(19) United States
(12) Patent Application Publication
(10) Pub. No.: US 2007/0267409 A1
(43) Pub. Date: Nov. 22, 2007

(54) ASSEMBLED CONTAINER FOR ROASTING FOOD

(75) Inventors: Robert G. Gard, San Carlos, CA (US); Glen T. Poss, Nine Mile Falls, WA (US); Robert Barker, Redwood City, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: COFFEE TECHNOLOGIES INTERNATIONAL INC., San Carlos, CA (US)

(21) Appl. No.: 11/751,576

(22) Filed: May 21, 2007

Related U.S. Application Data
(63) Continuation-in-part of application No. 11/029,168, filed on Jan. 3, 2005, now Pat. No. 7,235,764.
Application No. 11/029,168 is a continuation of application No. 10/065,419, filed on Oct. 16, 2002, now abandoned.

(51) Int. Cl. H05B 6/80

(52) U.S. Cl. 219/730

(57) ABSTRACT

An assembled container for roasting food is placed on its side in a microwave oven so that the turntable of the microwave oven imparts tangential force, which the assembled container translates into motion to the food being roasted. The assembled container includes various shapes, such as a squat cup, a bowl, or an undulated structure. A reusable assembled container is formed from a suitable material so that it can be cleansed after usage for the next roasting.

### CROSS-REFERENCES TO RELATED APPLICATIONS

This application is a continuation-in-part of U.S. patent application Ser. No. 11/029,168, filed Jan. 3, 2005, which application is a continuation of U.S. patent application Ser. No. 10/065,419, filed Oct. 16, 2002, both of which are hereby incorporated by reference in their entirety.

### BACKGROUND

Recent years have seen an explosion of interest in gourmet coffee products and the interest has not been limited to the purchase of coffee-based beverages from vendors who prepare the beverage on premise and purvey it to consumers over the counter. The desire is now for the ultimate in freshness and flavor and that is roasting the coffee on site at the coffee shop and or at home. Coffee roasting is a two-step process. The outside of a bean is covered with a husk which also follows a fold into the center of the bean. As it is roasted, the coffee bean expands and literally “pops” to shed the outer husk. If the bean is properly roasted, the center of the bean further expands and allows some of the internal husk to break free of the bean.

Currently coffee beans are roasted via two common methods and a third one that is less common. The common methods are convection and conduction. Convection uses a heated air stream to heat the bean and “float” it in an air stream to reduce burning; however, this heated air system also strips away through evaporation a large amount of the coffee oils that are vital components in the flavor of superior coffee. Conduction is the other roasting method and in this system only heat from the externally heated open metal drum is used to roast the bean through direct contact. The conduction method rotates the drum for agitation to prevent scorching the coffee bean. The conduction system still uses air that is circulated in the drum to remove heat and smoke and results in loss of lighter coffee oils (and their flavor) just as in the convection system. The conduction system also prevents the controlled and easy transfer of the heat to penetrate the husk and cause the internal mass of the bean to quickly rise to a desired temperature. This causes moisture and oil within the bean to vaporize and expand, thereby applying pressure to the husk and resulting in the popping of the bean. The mass of the bean expands and the husk is freed from the bean. The other method of roasting beans is the use of steam as shown in U.S. Pat. No. 5,681,607, issued on Oct. 28, 1997, to Maki, et al. Roasting with superheated steam, however, tends to make the coffee much more sour. The steam process uses a high-pressure vessel and high steam temperatures and pressures making this system potentially very dangerous for the home and commercial user. The steam system alone cannot provide the dark and very dark roasts that are desired by most of the coffee drinking public. Various embodiments of the invention use “latent” steam in combination with convection, conduction, infrared, and microwave heating to provide a full spectrum of roasting levels. Latent steam is a result of the water that is contained in the coffee beans (generally 10%-12% by weight) and is boiled out of the bean during the initial convection/conduction/microwave heating that is part of the roasting process. This latent steam is a contributor to making the coffee more “mellow,” as in the steam-only process; but because it is part of the bean, it requires no separate boiler and due to the design of the cartridge is of low pressure and thereby is not a hazard.

Other problems with conductive, convection and steam roasting include a situation where a bean is roasted at too low of a temperature, the moisture build-up is sufficiently slowed as to allow the vapor to escape without building up sufficient pressure to pop the bean. When this occurs, the bean will be of smaller size than if proper roasting occurs and has a green grassy flavor. On the other hand, if a bean is roasted at too high of a temperature, the bean will be burned, i.e., overly caramelized, and taste will suffer. In some cases, high temperature roasting will result in a burning of the husk. As the husk serves as a moisture barrier to allow pressure to build up during roasting, the burning of the husk destroys the moisture barrier and allows the moisture to escape without building up sufficient pressure to pop the bean. The second stage of roasting occurs once the bean pops. Here, the heating of the oil within the bean results in chemical changes to roast the bean to the taste of a particular consumer. In many instances, continued roasting of the bean after popping causes a further expansion of the bean. To achieve optimum roasting, it is necessary that the beans be uniformly heated internally via microwaves and externally via conduction, convection and latent steam while not allowing any of the oils and essences that are components of the flavor to escape into the air prior to grinding. If the heating is not uniform, some of the beans may pop early in the roasting process and others, not at all. Consequently, uniform flavor cannot be obtained. Similarly, it is necessary that roasting temperature be properly controlled to assure proper flavor development which cannot occur if the roasting temperature is either too low or too high.

Other common problems with current coffee roasters include the issue of smoke and excessive aroma. The smoke and excessive aroma is dealt with on existing commercial roasters by the use of stack scrubbers and after burners, the problem is dealt with on home coffee roasters by there recommend use out doors. Other problems that the current roasters have is high energy cost per pound of beans either using gas or electricity. This is on the order of 50% higher than microwave driven roasting. The present invention is directed to overcoming one or more of the above problems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The claimed subject matter appears in various forms. One form includes an assembled container for roasting food in a microwave oven, which comprises a shell defining a first chamber bounded at one end by a closed circular plane base and at the other end by an opened circular plane base. The opened circular plane base is coupled to the closed circular plane base by a side to form a shape selected from a group consisting of a squat cup, a shape with a flat bottom, a shape with a convex bottom, a shape with a concave bottom, and a shape whose side are periodically undulated. The assembled container further comprises a second layer composed from a susceptor laminate material and shaped into a second chamber, the second chamber being housed by the shell. The assembled container further comprises a portal layer positioned over the opened circular plane base to close the first chamber and the second chamber to contain food. The portal layer includes an opening large enough to allow food to be placed into or poured out of. The assembled container further comprises a film placed over the portal layer to cover the opening while allowing the doneness of the food to be visibly observed.

The claimed subject matter also includes another form, which is a susceptor laminate article. The article comprises a substrate and a susceptor material being adhered to a portion of the substrate while the remaining portions of the substrate are exposed.

The claimed subject matter also includes a third form, which is an assembled container for roasting food in a microwave oven. The assembled container in this third form includes a glass shell defining a first chamber bounded at one end by a closed circular plane base and at the other end by an opened circular plane base. The opened circular plane base is coupled to the closed circular plane base by a side. The closed circular plane base has a concave bottom that projects away from the opened circular plane base. The concave bottom defines a circular opening that is axially aligned with the center of the concave bottom to receive a filter or a valve to regulate pressure inside the assembled container. The assembled container includes a second layer composed from a pulp material and shaped into a second chamber. The second chamber is housed by the first chamber. The assembled container includes a third layer composed from a susceptor laminate material and shaped into a third chamber. The third chamber is housed by the second chamber. The assembled container includes a glass lid with a top circular plane base and a bottom circular plane base, the bottom circular plane base has a recess into which a rubber gasket is inserted and a collar for engaging securely with the glass shell to allow food to be roasted when the shell is placed on its side to contact a turntable of the microwave oven.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1. comprises a cross-sectional view of the cartridge assembly that includes (13) the substantially conical cartridge with recess (2) in the side placed co-axle to and evenly around the circumference to provide a pathway around the susceptor liner for latent steam to transfer to the outside and as a reinforcement for the pulp formed canister. Area (3) is a cross-sectional view of the die cut flat but formed susceptor liner. Item (4) is a cross-sectional view of the die cut card stock closure with filler port (8) die cut into item (4) and roasting color guides (17) placed by opening. Item (5) is a cross section view of the polyester film that is laminated to the closure 4 using starch-based adhesive suitable for contact with food.

FIG. 2. is a cross sectional view of the completed cartridge loaded with coffee beans (19) and showing the closure glued down with a starch based glue suitable for contact with food on surface (18);

FIG. 3 is an external side view of the completed cartridge (13);

FIG. 4A is an external perspective view of the complete cartridge (13);

FIG. 4B is an exploded view of component parts 2, 3, 4, and 5;

FIG. 5 is a view of the completed pod in a schematic view of a microwave oven.

FIG. 6 is a cut away view of the susceptor laminate showing construction.

FIG. 7A is a perspective view of one embodiment of an assembled container to contain food products for roasting in a microwave oven;

FIG. 7B is a cross-sectional, perspective view of the assembled container illustrated in FIG. 7A;

FIG. 7C is an exploded, perspective view of the assembled container illustrated in FIGS. 7A, 7B;

FIG. 8A is a perspective view of a susceptor laminate layer according to one embodiment;

FIGS. 8B-G are plan views of various embodiments of a susceptor laminate layer;

FIG. 9A is a cross-sectional, perspective view of one embodiment of an assembled container to contain food products for roasting in a microwave oven;

FIG. 9B is an exploded, perspective view of various layers of the assembled container;

FIG. 10A is a cross-sectional, perspective view of one embodiment of an assembled container to contain food products for roasting in a microwave oven;

FIG. 10B is an exploded, perspective view of various layers of the assembled container;

FIG. 11A is a cross-sectional, perspective view of one embodiment of an assembled container to food products for roasting in a microwave oven;

FIG. 11B is an exploded, perspective view of various layers of the assembled container;

FIG. 12A is a cross-sectional, perspective view of one embodiment of an assembled container to contain food products for roasting in a microwave oven;

FIG. 12B is an exploded, perspective view of various layers of the assembled container; and

FIG. 13A is a cross-sectional, perspective view of one embodiment of an assembled container to contain food products for roasting in a microwave oven;

FIG. 13B is an exploded, perspective view of various layers of the assembled container.

### DETAILED DESCRIPTION

The principal object of the invention is to provide a new and improved coffee bean roasting apparatus and process suited for home or commercial use. According to one facet of the invention, an exemplary embodiment of an apparatus for roasting coffee beans includes a closed cartridge that is constructed of non-porous or semi porous material. One of the preferred embodiments of the cartridge is to be made by pulp forming. The cartridge contains a controlled portion of coffee and the coffee beans occupy 29% of the internal volume of the cartridge to allow for expansion during the roasting process. The cartridge may also be used for long term storage and handling of the coffee. The cartridge is further completely lined with a floating liner that is comprised of a printed dipole antenna or a thin film conductor that selectively absorbs microwave radiation (susceptor). This susceptor is made generally of a printed dipole antenna on a polyester film that is laminated to a zero acid neutral pH paper. The susceptor only partly converts the microwaves to heat and allows the unabsorbed microwave energy to be absorbed by the coffee beans to effect internal heating. The cartridge may be of cylindrical, spherical or conical shape. If the cartridge is of cylindrical or conical shape, one end will be closed with an airtight closure that may be of card stock paper or pulp formed material. The closure may contain a see through window of polyester or other suitable transparent or translucent film so that the degree of roast can be visually assessed. The cartridge is placed in a microwave environment, which may be either a commercial/residential microwave oven or a purpose designed microwave chamber. The cartridge is then caused to roll either by interaction with, in the case of an existing domestic/commercial microwave oven, the turntable and a fixed feature imparting the motion of the turn table on to the cartridge. Alternately a separate microwave safe device can be provided to cause the cartridge to rotate at the desired speed and for the desired duration. The preferred embodiment of the cartridge is that it is generally conical in shape with a blunted point. The details of the roasting process is as follows. In operation the cartridge is placed in the microwave cavity of either a home, commercial or purpose built microwave oven turn in a orientation that allows the cartridge to roll when it interacts with the fixed bar imparting the turntables rotation to the cartridge. The fixed bar is an addition to an existing microwave oven or may be replaced with a dedicated device to allow the cartridge to roll. The cartridge rotating causes the coffee beans to tumble as they move up the “high” side of the cartridge and when they exceed the maximum angle of repose cascade down allowing for all the beans to be in direct contact with the susceptor. This constant tumbling agitation allows all the beans to be heated in all 4 forms evenly. The microwave power is projected into the cavity and is omni-directional with the microwave energy coming from all directions this allows for the multiple heating methods to take place. The beans that are in direct contact with the susceptor are directly heated by conduction and the choice of the susceptor allows for precise temperature generation when energized with microwave energy preventing scorching. The susceptor laminate is formed into a hollow conical/cylindrical/spherical shape and the area that is not in contact with the coffee beans are still converting microwave energy but into infrared heat. The infrared heat indirectly heats the beans by convection heating the steam that the beans emit as they start to roast. The infrared also directly heats the beans at a lower temperature that the conduction heating of direct contact. The microwave energy that is not converted by the susceptor is absorbed by the oils, water and proteins inside of the coffee beans assisting in the generation of an even roast through out as well as using the consumed power efficiently. The coffee beans as they heat first degas or boil off their water content and the water vapor tries to escape to the outside. As the water vapor attempts to transpire to the outside it encounters the pulp formed cartridge, causing the pulp to swell and form a highly restrictive filter that traps a high percentage of the latent steam. The cartridge also traps the aroma and flavors that would normally be washed away by the airflow in other roasters. The roasting process is complete when the operator determines the coffee is roasted enough by visual means through the filling port, or by auditory by the second crack of the coffee beans while they roast. In its preferred embodiment the recommended roasting time and power level will be printed on the cartridge as well as other information as to origin of the coffee bean and expected tastes at degrees of roast featured by the roasting gauge. In the preferred embodiment four specific color dots labeled L, M, MD, and D are printed by the filler port and are keyed to the written description of the flavor expectation for that degree of roast. In the preferred embodiment the cartridge will be made of pulp formed paper and form a semi conical shape with reinforcing ridges that also provide an area for vapor transpiration around the non-attached susceptor liner. The preferred embodiment also uses a end closure of cardboard or pulp formed material that contains a hole that is covered by a transparent or semi-transparent material to load the cartridge with coffee beans. The preferred embodiment includes a fixture to translate the motion of the existing turntable into rotation of the cartridge; alternately a separate device may be used to rotate the cartridge in the microwave environment. The separate device may be either spring, battery or powered by the microwave energy of the microwave oven. Other objects and advantages will be apparent from the following specification taken in connection with the accompanying drawings.

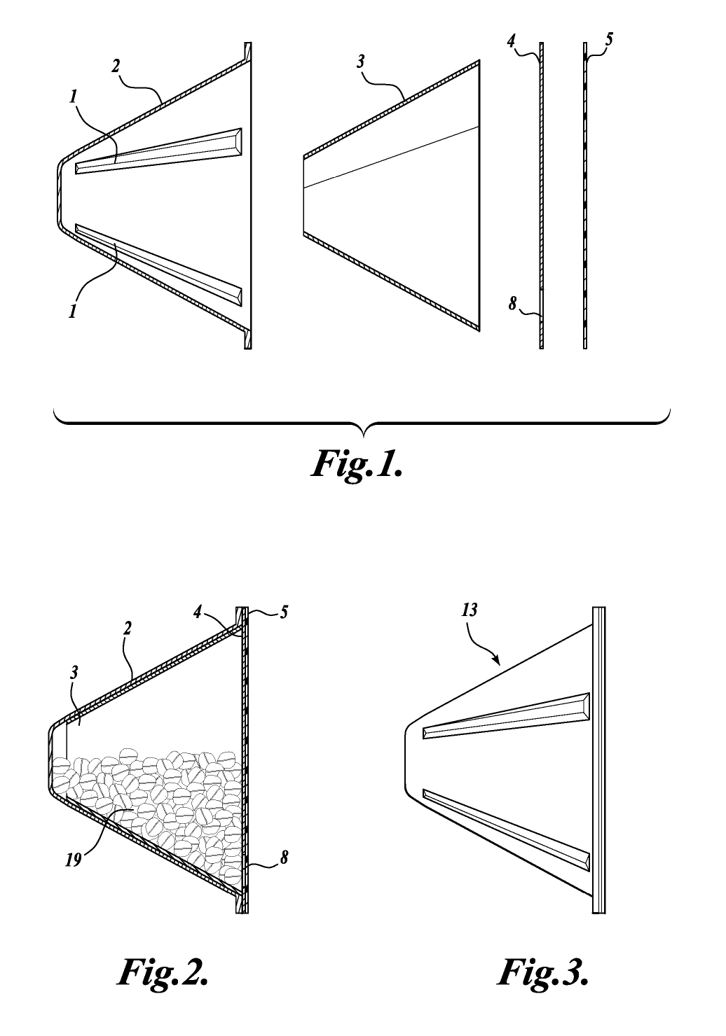

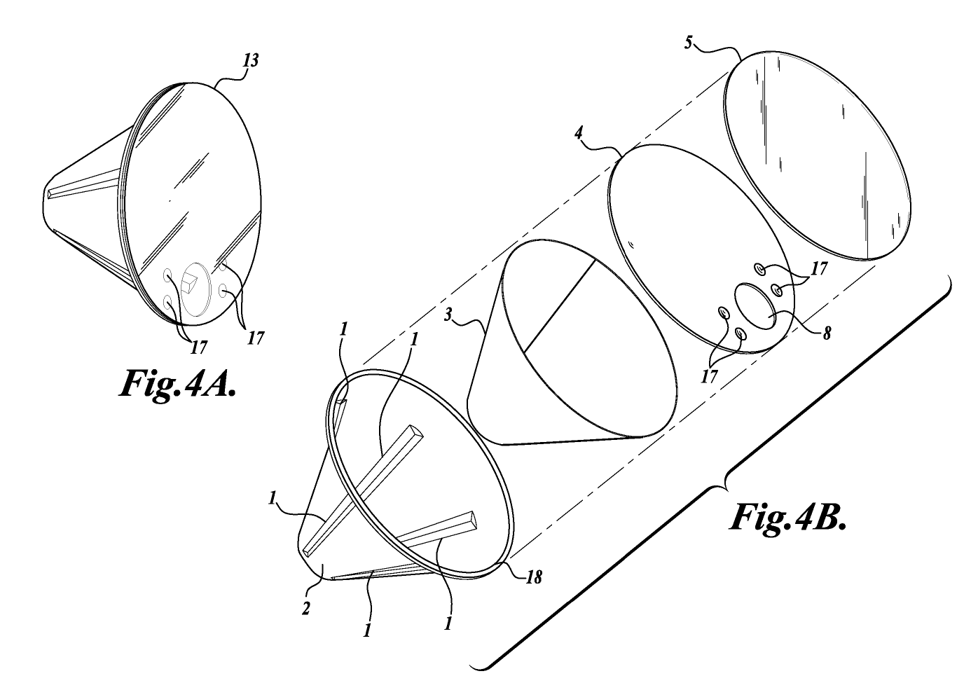

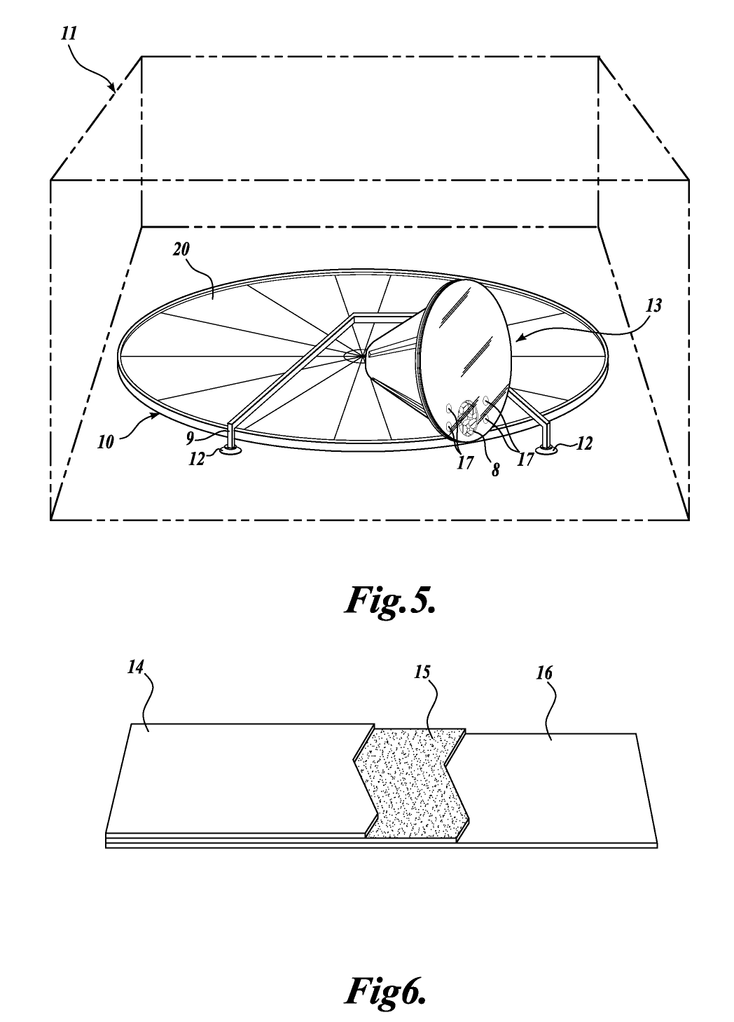

Hereinafter, this invention will be described in detail with reference to the drawings. As illustrated in FIGS. 1-6 the present invention comprises a cartridge 13 that is made of a semi-porous material that in the preferred embodiment will be pulp formed paper. The cartridge may be conical, cylindrical, or spherical in shape and will contain recesses 1 for the purpose of supplying an air gap for the susceptor laminate 3. The susceptor laminate 3 is formed from flat sheet and is die cut into a semi circle to allow the placement of the laminate into the body of the cartridge 13 and is not affixed in any manner. The susceptor laminate 3 is composed of 3 layers as shown in FIG. 6 the outer layers 14 and 16 are preferably Kraft paper or any zero acid neutral pH paper and is laminated to the susceptor film 15 using adhesive that is approved for food contact. The susceptor film 15 is comprised of a printed dipole antenna or a thin film conductor on a polyester substrate. The closure lid 4 in the preferred embodiment is composed of card stock made of recycled paper and is rated for food contact. The closure lid 4 has a hole 8 cut into it for the use of filling and emptying the canister. The hole 8 can be placed in any location on the closure lid 4 and will be of sufficient size to allow for the purpose of filling and emptying the canister. The color dots 17 are in close proximity to the hole 8 and are provided for a color reference of the roasted coffee. The color dots 17 are each of a different color but generally reflect the colors of roasted coffee from light to dark roast. The color dots 17 have reversed out of the color field the letters L, M, MD and D. The color dots 17 and associated letters are used for reference to the flavor and aroma of the coffee when roasted to that level. The closure lid 4 also has provisions for printing that can include but are not limited to the operation instructions, type of coffee bean or blend, origin of the coffee bean, tasters comments on flavor and suggested degree of roasting. The clear or translucent non-porous layer 5 is laminated to the closure 4 after the closure is printed and the hole 8 has been die cut. The clear or translucent layer 5 is in the preferred embodiment 0.01 mm thick polyester but can be of other thickness and is preferably clear but can be translucent. The cartridge 13 is assembled by rolling the susceptor 3 into a shape that will fit into the cartridge and rests on the recesses 1. The coffee beans are then loaded into the canister. The green coffee beans 19 can be of any amount and from any locations and can be of either of two primary types arabica and or robusta or any combination of either. The volume of green coffee beans will not exceed ½ the volume of the completed canister. The closure lid 4 completed with its laminated clear or translucent layer is then glued on to the canister via a flange 18. The glue will be of food contact rated material and may be applied by roller, spray or bead. The cartridge is used in any microwave oven, commercial, consumer or purpose built but in the preferred embodiment it is for use in commercial and consumer microwave ovens. The completed canister 13 as shown FIGS. 3 and 4 is used by placing the canister 13 into a microwave cavity 11 as shown in FIG. 5 and on the turn table 10 or alternately on a specific device that is a separate device may be used to rotate the cartridge in the microwave environment. The separate device may be either spring, battery or powered by the microwave energy of the microwave oven. The canister 13 is oriented so that the circular cross section is perpendicular to the turn table 10 or the separate device so as to allow the cartridge 13 to roll. The turn table 10 is in the preferred embodiment covered with a microwave proof silicon rubber pad 20 that is to enhance friction between the cartridge 13 and the turntable 10. The pad 20 in the preferred embodiment will have a shallow conical cross section to allow for the green coffee beans 19 in the cartridge 13 to flow to the closure end 4. The microwave cavity also has a fixture 9 that is attached to the floor of the microwave cavity 11 by feature 12. The feature 12 can be of any permanent or temporary attachment so as to prevent the fixture 9 from moving when in contact with cartridge 13. The function of the fixture 9 is to prevent the cartridge 13 from rotating around on the turntable 11 and pad 20 and there by imparts the rotation of the turntable 11 and pad 20 onto the cartridge 13. This rotation is a component of the roasting process. After placement of the cartridge 13 the microwave oven may be energized as per the time and power level as per the instructions for the product. When the coffee 19 is roasted to the desired level the cartridge 13 is then removed from the microwave cavity 11 and is opened by either removal of the layer 5 or by removing the material covering the hole 8 and then pouring out the roasted beans for grinding. As will be appreciated from the above description, the present invention provides a convenient and easy to use device and process for the roasting of green coffee beans as ingredient that is suitable for use in microwave ovens. While a particular form of the invention has been illustrated and described, it will be apparent that various modifications can be made without departing from the spirit and the scope of the invention. Accordingly, it is not intended that the invention be limited except as by the appended claims.

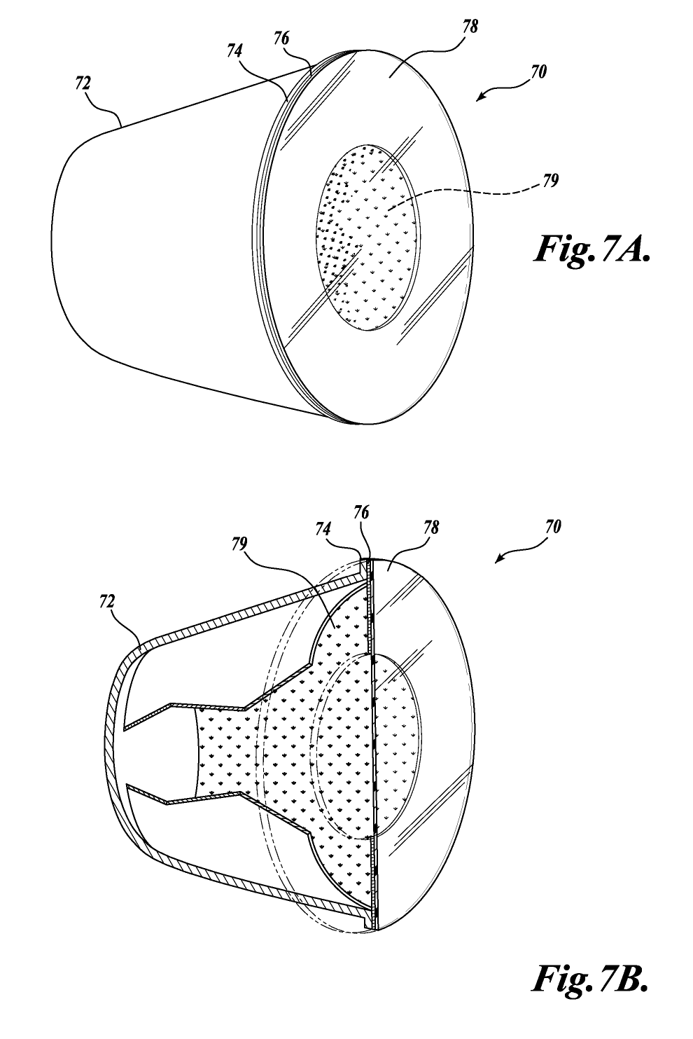

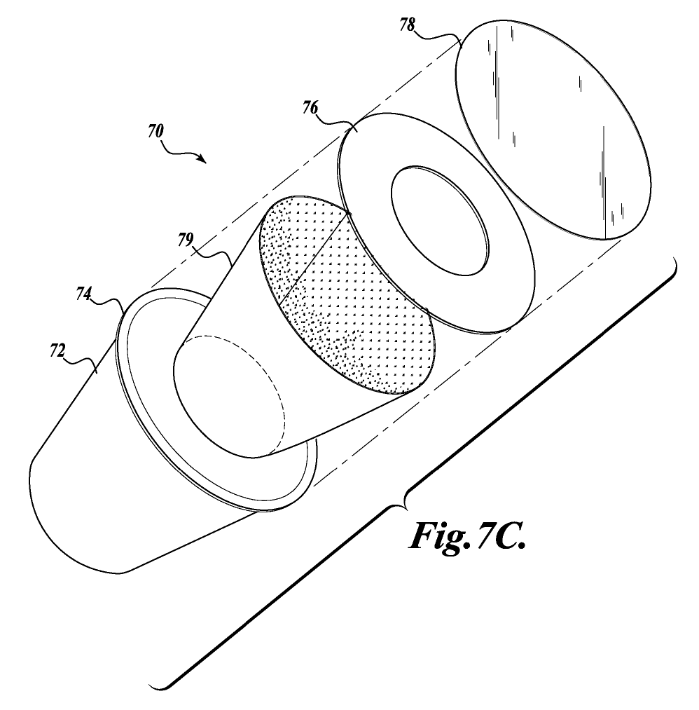

FIGS. 7A-7C illustrate one embodiment of an assembled container 70 adapted for containing food products, such as nuts, seeds, or beans, for roasting in a microwave oven. The assembled container 70 includes a shell 72, which has a closed circular plane base and an opened circular plane base, which together form a first chamber. The first chamber has a side, which is straight, slightly sloped, and of a distance dimension suitable to create a squat cup shape. The closed circular plane base has a diameter that ranges from about 45% to about 59% of a diameter of the opened circular plane base. The shell 72 includes a lip 74 with a diameter that is slightly larger than the diameter of the opened circular plane base so that the lip 74 protrudes perpendicularly.

The assembled container 70 includes a susceptor laminate layer 79, which has a distal end and a proximal end, which are brought together to form a second chamber. The second chamber is housed inside the first chamber. The assembled container 70 includes a portal layer 76 in the shape of an annular ring having a surface with an outer diameter and an inner diameter. The outer diameter of the annular ring has similar dimensions to the diameter of the lip 74. The inner diameter of the annular ring defines an opening large enough to allow nuts, seeds, or beans to be placed in or poured out of the shell 72. An annular surface is defined between the outer diameter and the inner diameter of the annular ring of the portal layer 76. A film 78 is coupled to the annular surface of the portal layer 76 using an adhesive that is suitably food-safe. A portion of the film 78 over the opening defined by the inner diameter of the annular ring allows observation of the doneness of the nuts, seeds, or beans being roasted.

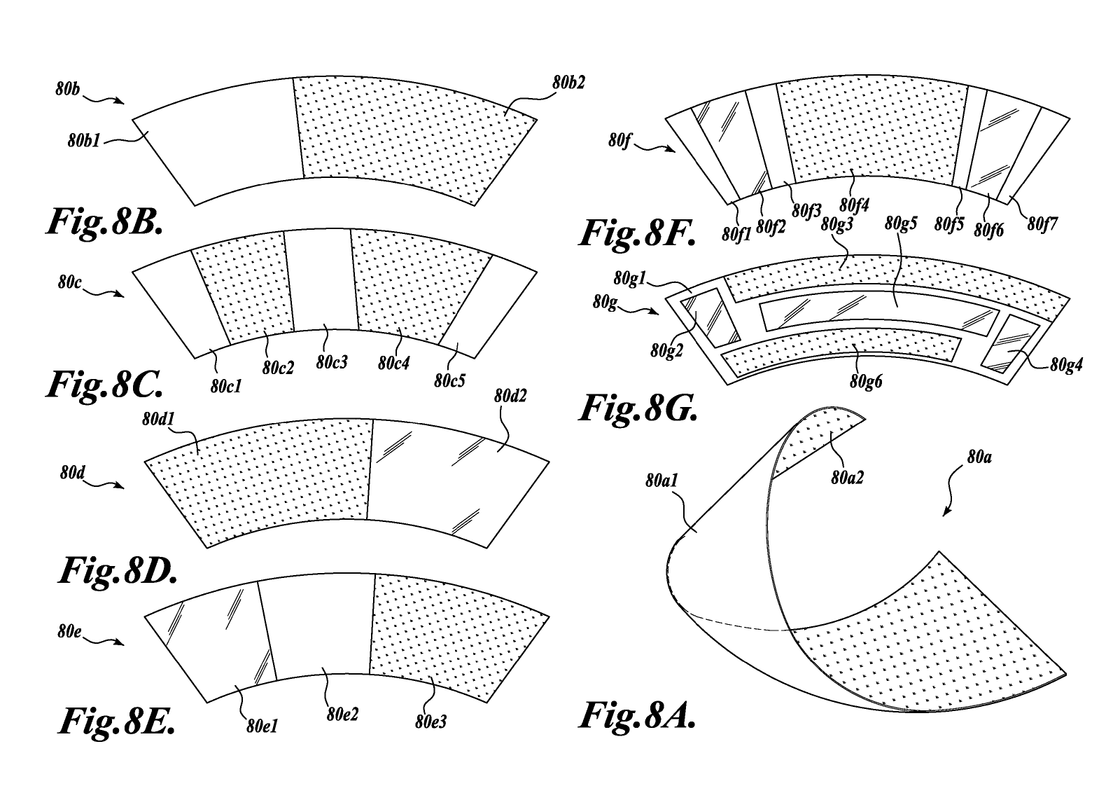

FIGS. 8A-8G below illustrate various embodiments of a susceptor laminate layer that can be used in any embodiments of an assembled container. Preferably, all susceptor laminate layer embodiments include a substrate formed from paper material, such as a blank paperboard, or alternatively, PET film, which can be used in the absence of the use of paper material. Various susceptor laminate layer embodiments include a combination of exposed paper material and susceptor laminate material, so as to reduce or inhibit charring, tipping, and uneven roasting of contained food. Various susceptor laminate material embodiments include combinations of exposed paper material, susceptor laminate material, and a metallic material, such as aluminum foil, to block a portion of microwave energy from being translated into heat inside the assembled container.

FIG. 8A illustrates one embodiment of a susceptor laminate layer 80a. The susceptor laminate layer 80a is formed form a suitable material, such as paper, and includes a bottom surface 80a1 and a top surface 80a2, which surface is subjacent to a susceptor laminate material adhering to the top surface 80a2. In this embodiment, the susceptor laminate material covers the entirety of the top surface 80a2.

FIG. 8B illustrates a second embodiment of a susceptor laminate layer 80b. A top surface of the susceptor laminate layer 80b is formed from a suitable material, such as paper, and includes a portion 80b1, at which the paper material is exposed, and is subadjacent to another portion 80b2, which is covered by a susceptor laminate material. FIG. 8C illustrates a third embodiment of a susceptor laminate layer 80c. A top surface of the susceptor laminate layer 80c is formed from a suitable material, such as paper, and includes portions 80c1, 80c3, and 80c5, at which the paper material is exposed, and respectively subadjacent to portions 80c2 and 80c4, which are covered by a susceptor laminate material.

FIG. 8D illustrates a fourth embodiment of a susceptor laminate layer 80d. A top surface of the susceptor laminate layer 80d is formed from a suitable material, such as paper, and is adhered to a portion 80d1, which is formed from a susceptor laminate material, and is adjacent to a portion 80d2, which is formed from an aluminum material or other suitable metallic materials. FIG. 8E illustrates a fifth embodiment of a susceptor laminate layer 80e. A top surface of the susceptor laminate layer 80e is formed from a suitable material, such as paper, and is adhered to a portion 80e1, which is formed from a metallic material, such as aluminum, and is adjacent to a portion 80e2, at which the paper material is exposed, and is adjacent to a portion 80e3, which is formed from a susceptor laminate material.

FIG. 8F illustrates a sixth embodiment of the susceptor laminate layer 80f. A top surface of the susceptor laminate layer 80f is formed from a suitable material, such as paper, and includes portions 80f1, 80f3, 80f5, and 80f7, which expose the paper material. Some of these portions are adjacent to portions 80f2 and 80f6, which are formed from a suitable metallic material, such as aluminum. Some other portions are adjacent to a portion 80f4, which is formed from a susceptor laminate material.

FIG. 8G illustrates a seventh embodiment of the susceptor laminate layer 80g. A top surface of the susceptor laminate layer 80g is formed from a suitable material, such as paper, which is exposed by a portion 80g1. Superjacent to the paper portion 80g1 includes portions 80g2, 80g4, and 80g5, which are formed from a suitable metallic material, such as aluminum. Also superjacent to the paper portion 80g1 includes portions 80g3 and 80g6, which are formed from a susceptor laminate material.

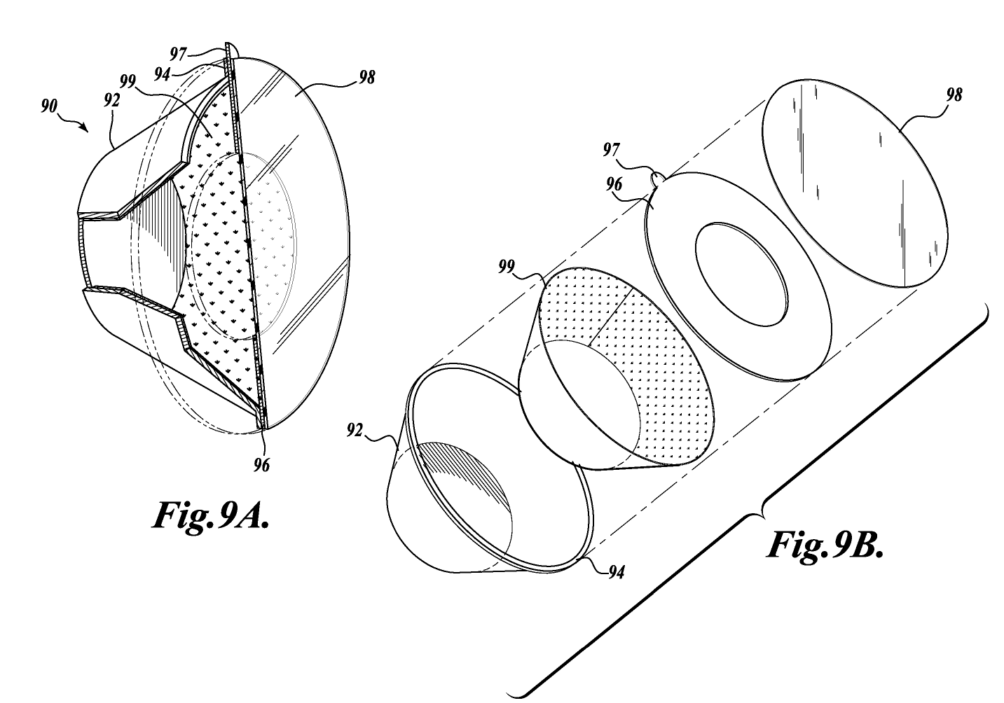

Various embodiments of an assembled container include various shapes, such as that discussed above in FIGS. 7A-7B and below in FIGS. 9A-12B. These shapes and other suitable shapes not discussed here can be used as long as they provide a bed contour for exposing the beans to substantially even heat transfer for roasting food products. Exemplary food products include nuts (e.g. cashews, peanuts, almonds), seeds (e.g. pumpkin, sunflower), beans (e.g. coffee), chicory, guarana, spices, flavoring components, and so on. In other words, the bed contour is of a shape that allows for substantially uniform penetration and distribution of heat transfer within the assembled container taken from an energy source, such as electromagnetic energy. Preferably, various embodiments of the assembled container are used by placing the assembled container on its side in the microwave oven and translating the circular motion of the turntable of the microwave oven to rotate the assembled container so as to impart motion to a food product contained by the assembled container.

Various embodiments of the assembled container include a shell, preferably made from various pulp or pulp slurry materials, such as papyrus, bamboo, coffee bean chaff, banana paper, hemp, jute, kenaf, sugar cane, eucalyptus, flax, esparto, straw, sisal, or any suitable suspension of organic cellulose fibers. Any suitable pulp or pulp slurry materials can be used as long as they allow manufacturing of a closed system that is sealed shut using a food-grade adhesive with no venting so that the steam generated inside the assembled container is captured and absorbed by the pulp or pulp slurry material to allow the pressure created by the steam to build and remain and then subside when a sealed-shut lid, such as that formed from a portal layer and a film layer, is removed. Alternatively, the pressure may naturally subside when the assembled container is allowed to cool to room temperature. Various embodiments preferably include a film made from a suitable material, such as Mylar or a film-covered paperboard. The film or film-covered paperboard is partially affixed so as to be easily torn off.

FIGS. 9A-9B illustrate another embodiment of an assembled container 90 adapted for containing food products for roasting in a microwave oven. The assembled container 90 includes a shell 92, which has a closed circular plane base, an opened circular plane base, and a side connecting the closed circular plane base and the opened circular plane base, which together form a first chamber. The closed circular plane base is parallel to the opened circular plane base. In one embodiment, the side is straight, and in another embodiment, the side is curved, and in a further embodiment, the side starts straight but is then curved toward the closed circular plane base. The closed circular plane base perpendicularly cuts the side so as to form a surface that is substantially flat. The shell 92 includes a lip 94 with a diameter that is slightly larger than the diameter of the opened circular plane base so that the lip 94 protrudes perpendicularly.

The assembled container 90 includes a susceptor laminate layer 99, which has a distal end and a proximal end, which are brought together to form a second chamber. The second chamber is housed inside the first chamber. The assembled container 90 includes a portal layer 96 in the shape of an annular ring having a surface with an outer diameter and an inner diameter. The outer diameter of the annular ring has similar dimensions to the diameter of the lip 94. The inner diameter of the annular ring defines an opening large enough to allow nuts, seeds, or beans to be placed in or poured out of the shell 92. An annular surface is defined between the outer diameter and the inner diameter of the annular ring of the portal layer 96. A film 98 is coupled to the annular surface of the portal layer 96 using an adhesive that is suitably food-safe. A portion of the film 98 over the opening defined by the inner diameter of the annular ring allows observation of the doneness of the nuts, seeds, or beans being roasted. Protruding from one side of the annular surface is a tab 97 usable to tear away the portal layer 96 from its adhesion to the lip 94.

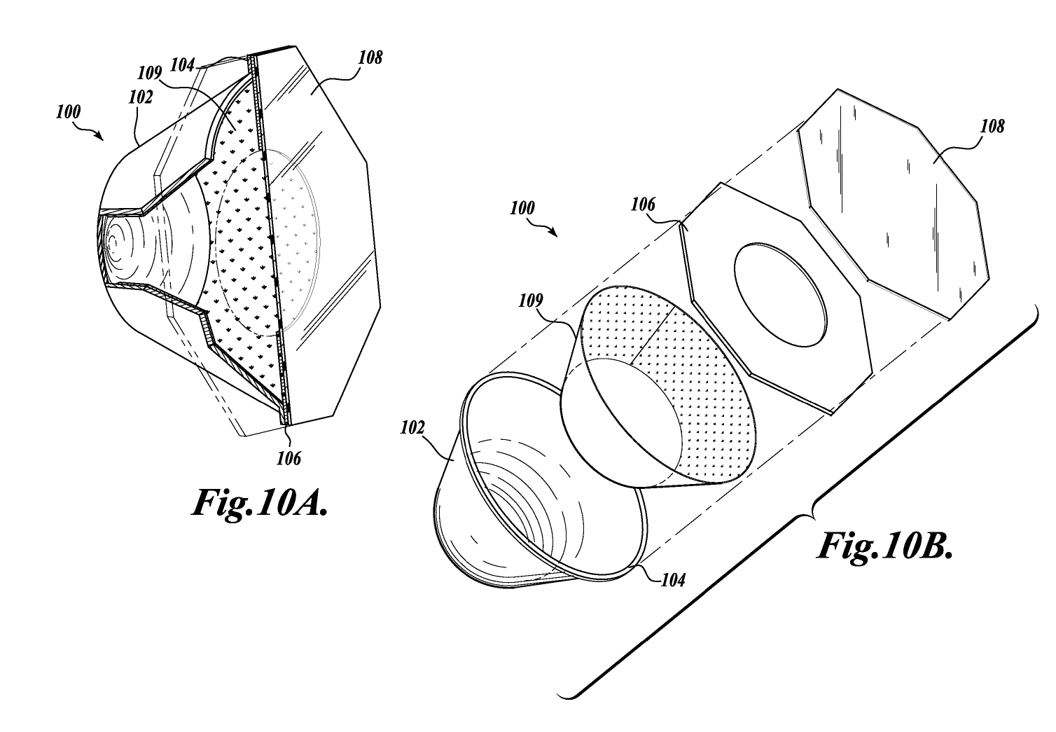

FIGS. 10A-10B illustrate a further embodiment of an assembled container 100 adapted for containing food products for roasting in a microwave oven. The assembled container 100 includes a shell 102, which has a closed circular plane base, an opened circular plane base, and a side connecting the closed circular plane base and the opened circular plane base, which together form a first chamber. The closed circular plane base is parallel to the opened circular plane base. In one embodiment, the side is straight, and in another embodiment, the side is curved, and in a further embodiment, the side starts straight but is then curved toward the closed circular plane base. The closed circular plane base has a convex surface, which protrudes away from the opened circular plane base. The shell 102 includes a lip 104 with a diameter that is slightly larger than the diameter of the opened circular plane base so that the lip 104 protrudes perpendicularly.

The assembled container 100 includes a susceptor laminate layer 109, which has a distal end and a proximal end, which are brought together to form a second chamber. The second chamber is housed inside the first chamber. The assembled container 100 includes a portal layer 106 in an octagonal shape, which defines a circular opening in the center of the octagonal shape. The portal layer 106 can be adhered to the lip 104. The circular opening of the portal layer 106 is large enough to allow nuts, seeds, or beans to be placed in or poured out of the shell 102. A surface is defined between the circular opening and the perimeter of the octagonal shape of the portal layer 106. A film 108 is coupled to the annular surface of the portal layer 106 using an adhesive that is suitably food-safe. A portion of the film 108 over the opening defined by the inner diameter of the annular ring allows observation of the doneness of the nuts, seeds, or beans being roasted.

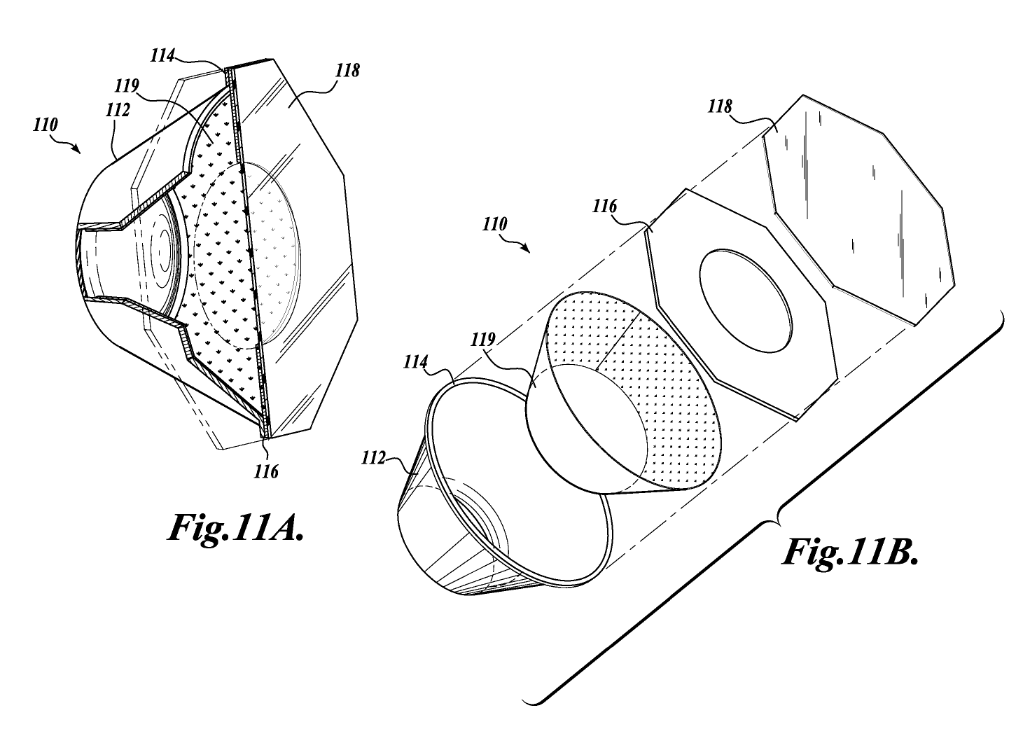

FIGS. 11A-11B illustrate an additional embodiment of an assembled container 110 adapted for containing food products for roasting in a microwave oven. The assembled container 110 includes a shell 112, which has a closed circular plane base, an opened circular plane base, and a side connecting the closed circular plane base and the opened circular plane base, which together form a first chamber. The closed circular plane base is parallel to the opened circular plane base. In one embodiment, the side is straight, and in another embodiment, the side is curved, and in a further embodiment, the side starts straight but is then curved toward the closed circular plane base. The closed circular plane base has a concave surface, which protrudes toward the opened circular plane base. The shell 112 includes a lip 114 with a diameter that is slightly larger than the diameter of the opened circular plane base so that the lip 114 protrudes perpendicularly.

The assembled container 110 includes a susceptor laminate layer 119, which has a distal end and a proximal end, which are brought together to form a second chamber. The second chamber is housed inside the first chamber. The assembled container 110 includes a portal layer 116 in an octagonal shape, which defines a circular opening in the center of the octagonal shape. The portal layer 116 can be adhered to the lip 114. The circular opening of the portal layer 116 is large enough to allow nuts, seeds, or beans to be placed in or poured out of the shell 112. A surface is defined between the circular opening and the perimeter of the octagonal shape of the portal layer 116. A film 118 is coupled to the annular surface of the portal layer 116 using an adhesive that is suitably food-safe. A portion of the film 118 over the opening defined by the inner diameter of the annular ring allows observation of the doneness of the nuts, seeds, or beans being roasted.

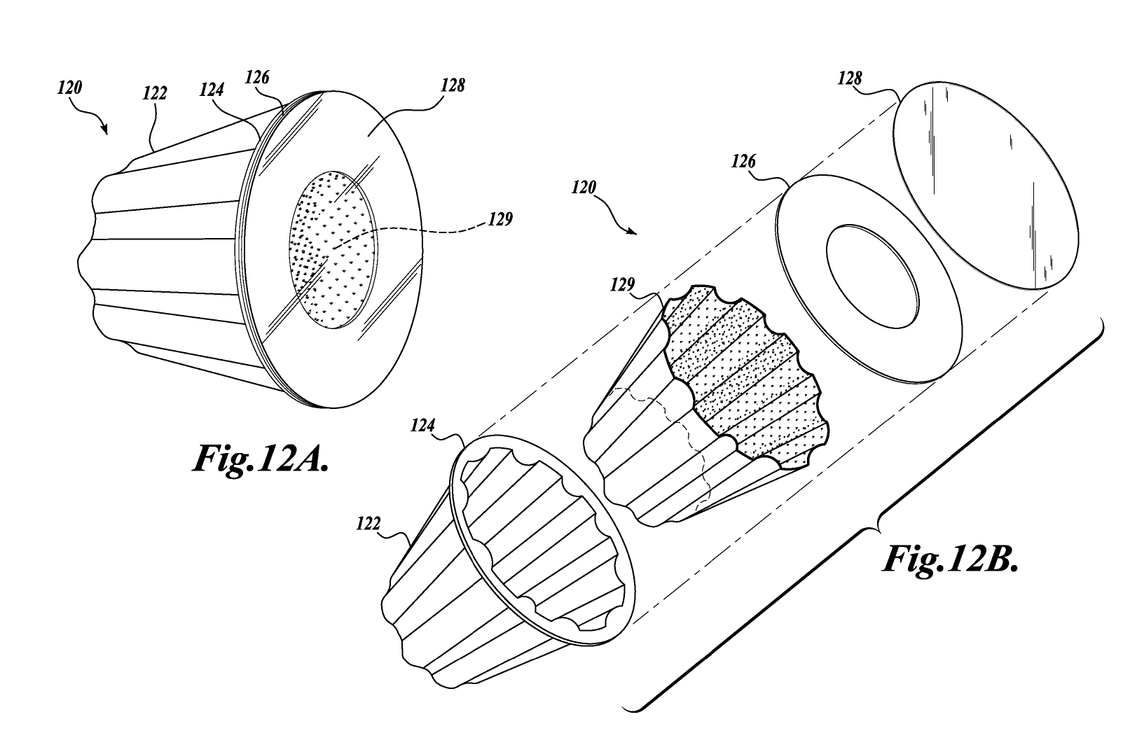

FIGS. 12A-12B illustrate another embodiment of an assembled container 120 adapted for containing food products for roasting in a microwave oven. The assembled container 120 includes a shell 122, which has a closed circular plane base, an opened circular plane base, and a side connecting the closed circular plane base and the opened circular plane base, which together form a first chamber. The closed circular plane base is parallel to the opened circular plane base. The side slopes from the opened circular plane base to the closed circular plane base. The closed circular plane base perpendicularly cuts the side so as to form a surface that is substantially flat. The side has an inner surface and an outer surface; both surfaces undulate so as to form repeating semi-circular ridges between which are flat troughs. The shell 122 includes a lip 124 with a diameter that is slightly larger than the diameter of the opened circular plane base so that the lip 124 protrudes perpendicularly.

The assembled container 120 includes a susceptor laminate layer 129, which has a distal end and a proximal end, which are brought together to form a second chamber. The second chamber is housed inside the first chamber. The second chamber has an inner surface and an outer surface; both surfaces undulate so as to form repeating semi-circular ridges between which are flat troughs. The assembled container 120 includes a portal layer 126 in the shape of an annular ring having a surface with an outer diameter and an inner diameter. The outer diameter of the annular ring has similar dimensions to the diameter of the lip 124. The inner diameter of the annular ring defines an opening large enough to allow nuts, seeds, or beans to be placed in or poured out of the shell 122. An annular surface is defined between the outer diameter and the inner diameter of the annular ring of the portal layer 126. A film 128 is coupled to the annular surface of the portal layer 126 using an adhesive that is suitably food-safe. A portion of the film 128 over the opening defined by the inner diameter of the annular ring allows observation of the doneness of the nuts, seeds, or beans being roasted.

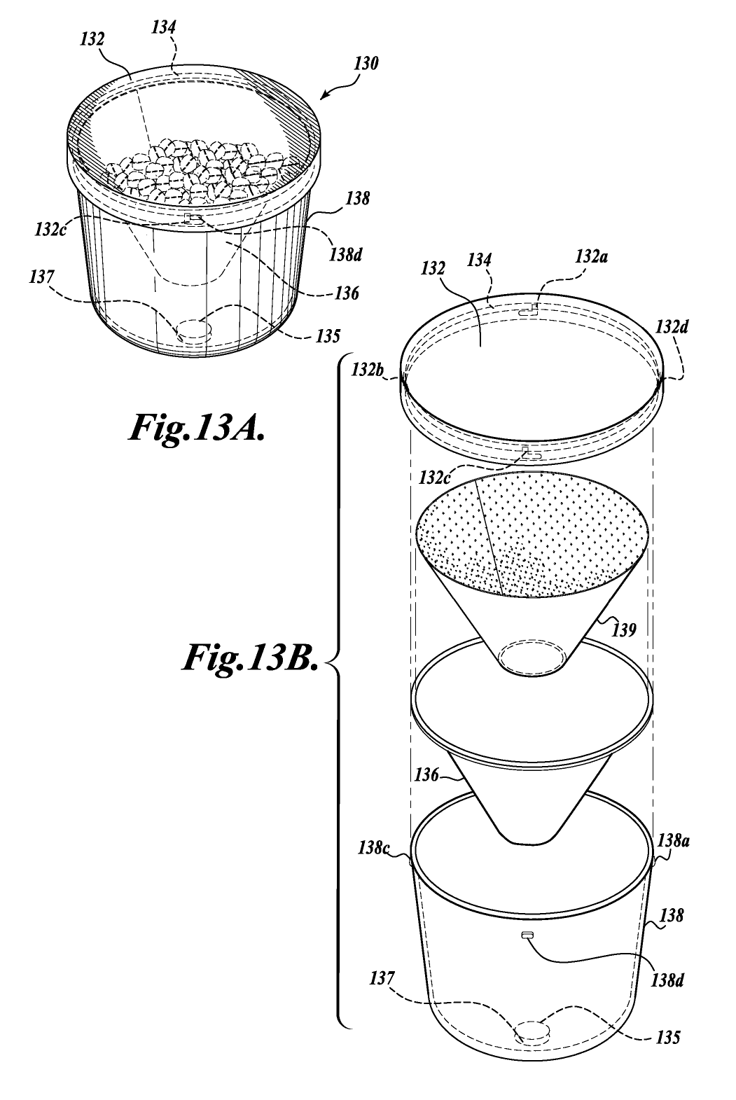

FIGS. 13A-13B illustrate as yet another embodiment of an assembled container 130 adapted for containing food products for roasting in a microwave oven. The assembled container 130 includes a shell 138, which has a closed circular plane base, an opened circular plane base, and a side connecting the closed circular plane base and the opened circular plane base, which together form a first chamber. Preferably, the shell is formed from a glass material, or other suitable materials that can be used in a microwave oven and after which can be cleansed for reusability. The closed circular plane base is parallel to the opened circular plane base and has a convex bottom which protrudes away from the opened circular plane base. The shell 138 has a thickness defines by an inner diameter and an outer diameter of the opened circular plane base. On the outer side of the shell 138, near the opened circular plane base that defines a rim, are about four, five, or six male members 138a-138d, preferably made from the same material as the shell 138. These male members are spaced apart periodically (e.g. if there are four male members, they are spaced apart about 90 degrees measured using polar coordinates from the axial center of the shell 138). The male members are rectangular in shape with rounded corners and are placed away from the rim at a distance that allows a lid 132 to mate with the male members and seals shut the assembled container 130.

In an embodiment in which the glass material is used with sufficient thickness to withstand the pressure of steam generated during roasting, the closed circular plane base of the shell 138 is solid with no openings. In another embodiment, the closed circular plane base of the shell 138 defines a circular opening 137 that is axially aligned with the closed circular plane base. A cylindrical filter 135 can mate with the circular opening 137 or a riser (not shown) that can communicate with the circular opening 137. Preferably, the cylindrical filter 135 is made of a natural fiber, microcell material, or a fiber glass material, and is used to filter volatile organic material and to allow pressure to escape. In a further embodiment, a permanent positive-pressure valve is used in place of the cylindrical filter 138 so as to allow an increase in pressure while volatile organic materials are filtered.

The assembled container 130 includes a second shell 136, which has a closed circular plane base, an opened circular plane base, and a side connecting the closed circular plane base and the opened circular plane base, which together form a second chamber. The second chamber is housed inside the first chamber. In one embodiment, the shape of the shell 138 is similar to the second shell 136. In other embodiments, the shape of the shell 138 is different from the shape of the second shell 136. Regarding the second shell 136, the closed circular plane base is parallel to the opened circular plane base. The closed circular plane base perpendicularly cuts the side so as to form a surface that is substantially flat. Preferably the second shell 136 is formed from a paper pulp material or a pulp slurry material. The assembled container 130 includes a susceptor laminate layer 139, which has a distal end and a proximal end, which are brought together to form a third chamber. The third chamber is housed inside the second chamber. Food products can be placed inside the third chamber.

The assembled container 130 includes the lid 132 formed, preferably, from the same material as the shell 138. The lid 132 has a top circular plane base and a bottom circular plane base. The bottom circular plane base includes a circular recess that has a diameter less than the diameter of the bottom circular plane base and into which a gasket 134 is inserted. A circular neck protrudes from the bottom circular plane base and has a thickness defines by an inner diameter and an outer diameter, which is equal to the outer diameter of the top circular plane base. The top circular plane base and the bottom circular plane base have the same diameter, which is larger than the outer diameter of the opened circular plane base of the shell 138. The inner diameter of the circular neck is also larger than the outer diameter of the opened circular plane base of the shell 138, such that the difference between these two diameters is appropriate to allow a close, secured closure of the assembled container 130. The gasket used with the lid 132 preferably is made from a food-safe material, such as rubber, and is fastened to the recess of the bottom circular plane base by a suitable fastener, such as a thermal resistance or thermal coupling adhesive.

The neck of the lid 132 includes an inside surface and an outside surface. The inside surface includes four, five, or six L-shaped, female members 132a-132d, which are periodically spaced apart (e.g., if there are four members, the members are spaced apart by about 90 degrees measured by polar coordinates with respect to the axial center of the lid 132). The L-shaped female members are preferably made of the same material as the lid 132. Each of the L-shaped female members has a short projection and a long projection, which are joined at a 90-degree angle into a corner to form the L shape. The short projection is oriented perpendicular to the top circular plane base whereas the long projection is oriented substantially parallel to the top circular plane base. Each distal end of the long projection is rounded and slightly sloped upward from its end to the corner toward the top circular plane base. Each proximal end of the long projection (near the corner) is slightly thickened. All L-shaped female members face the same direction tangentially. To tightly seal the assembled container 130, each L-shaped female member of the neck of the lid 132 mates with a male member of the shell 138 so that the male member slides upward over the long projection of the L-shaped female member from the distal end to the proximal end where the male member rests near the corner of the L-shaped female member.

While illustrative embodiments have been illustrated and described, it will be appreciated that various changes can be made therein without departing from the spirit and scope of the invention.

1. An assembled container for roasting food in a microwave oven, comprising:
a shell defining a first chamber bounded at one end by a closed circular plane base and at the other end by an opened circular plane base, the opened circular plane base being coupled to the closed circular plane base by a side to form a shape selected from a group consisting of a squat cup, a shape with a flat bottom, a shape with a convex bottom, a shape with a concave bottom, and a shape whose side is periodically undulated;
a second layer composed from a susceptor laminate material and shaped into a second chamber, the second chamber being housed by the shell;
a portal layer positioned over the opened circular plane base to close the first chamber and the second chamber to contain food, the portal layer including an opening large enough to allow food to be placed into or poured out of; and
a film placed over the portal layer to cover the opening while allowing the doneness of the food to be visibly observed.

2. The assembled container of claim 1, wherein the portal layer and the film seals shut the assembled container.

3. The assembled container of claim 1, wherein the side of the shell is placed in contact with a turntable of the microwave oven so as to translate motion to the food while roasting.

4. The assembled container of claim 1, wherein the portal layer includes a tab.

5. A susceptor laminate article, comprising:
a substrate; and
a susceptor material being adhered to a portion of the substrate while the remaining portions of the substrate are exposed.

6. The susceptor laminate article of claim 5, wherein the substrate is formed from a paper material or a PET material.

7. The susceptor laminate article of claim 6, wherein a first exposed substrate portion is adjacent to a first susceptor material portion, which is adjacent to a second exposed substrate portion, which in turn is adjacent to a second susceptor material portion, and which is further in turn adjacent to a third exposed substrate portion.

8. The susceptor laminate article of claim 6, wherein a susceptor material portion on a portion of the substrate is adjacent to another portion of the substrate which is adhered to an aluminum material.

9. The susceptor laminate article of claim 6, wherein an aluminum material portion on a portion of the substrate is adjacent to an exposed portion of the substrate, which in turn is adjacent to a susceptor material portion on another portion of the substrate.

10. The susceptor laminate article of claim 6, wherein a first exposed portion of the substrate is adjacent to a first aluminum material portion on a first portion of the substrate, which in turn is adjacent to a second exposed portion of the substrate, which is also adjacent to a susceptor material portion on a second portion of the substrate, which is further adjacent to a third exposed portion of the substrate, which is further adjacent to a second aluminum material portion of a third portion of the substrate, and is yet further in turn adjacent to a fourth exposed portion of the substrate.

11. The susceptor laminate article of claim 6, wherein the susceptor laminate article includes four sides, the substrate being extended to all four sides, a first aluminum material portion being located proximal to the first and second sides, a first susceptor material portion being adjacent to the second side and being located proximal to the first aluminum material portion, a second aluminum material portion being located proximal to the first aluminum material portion and the first susceptor material portion, a third aluminum material portion being located proximal to the first susceptor material portion, the third side, and the second aluminum material portion, a second susceptor material portion being located proximal to the first, second, and third aluminum material portion and the third and fourth sides, the substrate being exposed so as to isolate each portion from the other portions.

12. An assembled container for roasting food in a microwave oven, comprising:
a glass shell defining a first chamber bounded at one end by a closed circular plane base and at the other end by an opened circular plane base, the opened circular plane base being coupled to the closed circular plane base by a side, the closed circular plane base having a convex bottom that protrudes away from the opened circular plane base;
a second layer composed from a pulp material and shaped into a second chamber, the second chamber being housed by the first chamber;
a third layer composed from a susceptor laminate material and shaped into a third chamber, the third chamber being housed by the second chamber; and
a glass lid with a top circular plane base and a bottom circular plane base and a neck protruding from the bottom circular plane base for engaging securely with the glass shell to allow food to be roasted when the shell is placed on its side to contact a turntable of the microwave oven.

13. The assembled container of claim 12, wherein the glass shell includes male members that are periodically spaced apart, each male member being rectangular in shape with rounded corners, the male members being formed from glass.

14. The assembled container of claim 13, wherein the glass lid includes a circular recess into which a gasket is inserted and is fastened to the recess of the bottom circular plane base of the glass lid with a thermal adhesive.

15. The assembled container of claim 14, wherein the glass lid includes L-shaped female members that are spaced apart, the female members being formed from glass and positioned on an inside surface of the neck of the glass lid.

16. The assembled container of claim 15, wherein each L-shaped female member is formed from a short projection and a long projection, the short projection forming a corner with a distal end of the long projection at a ninety degree angle.

17. The assembled container of claim 16, wherein each long projection of each L-shaped female member is substantially perpendicular parallel to the top circular plane base of the lid and is pointed in the same direction.

18. The assembled container of claim 17, wherein a proximal end of the long projection of each L-shaped female member is rounded and the distal end is slightly thickened to secure the male member to the corner.

19. The assembled container of claim 12, wherein the closed circular plane base of the glass shell defines an opening for receiving a filter to filter volatile organic materials and also to regulate pressure in the roasting.

20. The assembled container of claim 19, wherein the filter is cylindrical in shape and is manufactured from a natural fiber, microcell material, or fiberglass material.
